(19) United States
(12) Patent Application Publication
(10) Pub. No.: US 2026/0111484 A1
(43) Pub. Date: Apr. 23, 2026

(54) System And Method For Semantic Video Metadata Search System at the Edge

(71) Applicant: Charter Communications Operating, LLC, St. Louis, MO (US)

(72) Inventor: Ramachandran ELUMALAI, Parker, CO (US)

(21) Appl. No.: 18/919,478

(22) Filed: Oct. 18, 2024

(51) Int. Cl. G06F 16/78; G06F 16/71; G06F 16/735

(52) U.S. Cl. CPC G06F 16/7867; G06F 16/71; G06F 16/735

(57) ABSTRACT

Systems and methods for performing semantic search on video metadata at an edge location may include a computing device that includes a processing system that processes video metadata received from at least one metadata source. The system may preprocess the metadata by removing stop words, punctuation, and irrelevant terms, converting text to lowercase, and performing lemmatization to standardize word forms. The pre-processed metadata may be transformed into high-dimensional vector embeddings using a pre-trained transformer. These embeddings may be indexed along with their corresponding video identifiers and image URLs. Each embedding may represent one or more metadata fields. The processing system may deploy the index to an edge location within a content delivery network (CDN) or edge computing platform.

### BACKGROUND

Content discovery systems have become integral to helping users navigate and access digital media across various formats, such as movies, music, books, and articles. These content discovery systems use algorithms and databases to organize, filter, and recommend content based on user preferences, past interactions, and search queries. Widely deployed across online platforms and streaming services, content discovery systems enhance user experiences by offering personalized recommendations and efficient browsing capabilities, enabling users to find relevant media more easily within vast digital libraries.

A specialized subset of content discovery systems focuses on video-based media, including movies and television shows. Video content discovery systems, commonly integrated into streaming platforms like Netflix®, Amazon Prime Video®, and Hulu®, use advanced algorithms to analyze metadata, user behavior, and viewing patterns. These video-based content discovery systems deliver personalized recommendations, helping users discover relevant content through search functions, curated lists, and suggestion engines. As video libraries grow in size and complexity, the need for more sophisticated content discovery systems capable of handling vast amounts of metadata has become increasingly desired.

Related video content discovery systems often rely on keyword-based search methods, which match exact terms in the metadata to user queries. While effective for basic searches, these systems are unable to understand deeper contextual relationships between search terms and video content and thus frequently produce irrelevant or incomplete results. New and more advanced systems that incorporate machine learning and natural language processing to better align search results with user intent may provide a more intuitive and accurate content discovery experience.

### SUMMARY

The various aspects include methods of performing semantic search on video metadata at an edge location, including receiving, at a processing system of a computing device, video metadata associated with one or more video assets from at least one metadata source, preprocessing the video metadata by removing stop words, punctuation, and irrelevant terms, converting the metadata to lowercase, and performing lemmatization to standardize word forms, converting the preprocessed video metadata into high-dimensional vector embeddings using a pre-trained transformer, indexing, by the processing system, the high-dimensional vector embeddings along with corresponding video identifiers and image uniform resource locators (URLs) in an index, in which each high-dimensional vector embedding corresponds to one or more metadata fields of the video metadata, and deploying the index to an edge location of a content delivery network (CDN) or edge computing platform.

In some aspects, the method may further include receiving, at the edge location, a semantic search query from a client application, preprocessing the semantic search query by removing stop words, punctuation, and irrelevant terms, converting the query to lowercase, and performing lemmatization to standardize word forms, converting the preprocessed semantic search query into a query vector embedding using the pre-trained transformer, searching the index using the query vector embedding to retrieve one or more matching vector embeddings corresponding to the video metadata, retrieving, based on the matching vector embeddings, corresponding video identifiers and image URLs associated with the one or more video assets, and sending to the client application the video identifiers and image URLs corresponding to the one or more video assets as search results. In some aspects, preprocessing the video metadata further includes parsing the video metadata into one or more metadata fields that each include at least one of a title, description, actor, or genre.

In some aspects, converting the preprocessed video metadata into high-dimensional vector embeddings further includes generating a separate high-dimensional vector embedding for each metadata field associated with the video metadata. In some aspects, the method may further include storing the high-dimensional vector embeddings and corresponding video metadata in a structured format that maintains index alignment between the video metadata and the high-dimensional vector embeddings. In some aspects, the pre-trained transformer is a BERT-based model configured to convert the video metadata and the semantic search query into high-dimensional vector embeddings.

In some aspects, the method may further include performing dimensionality reduction on the high-dimensional vector embeddings before indexing the vector embeddings at the edge location, in which the dimensionality reduction includes at least one or more of principal component analysis (PCA), or scalar quantization. In some aspects, performing scalar quantization includes applying 8-bit or 16-bit quantization to reduce the memory and storage requirements for the high-dimensional vector embeddings at the edge location.

In some aspects, indexing the high-dimensional vector embeddings further includes indexing the vector embeddings using a similarity-based search index, in which the similarity-based search index is created using FAISS. In some aspects, receiving the semantic search query from the client application further includes transmitting the semantic search query to the edge location from a client device, the client device being associated with a video streaming or content discovery application. In some aspects, retrieving corresponding video identifiers and image URLs further includes deduplicating the search results to remove duplicate entries resulting from multiple vector embeddings corresponding to the same video asset. In some aspects, the edge location includes a set-top box or an edge computing device deployed within a content delivery network.

In some aspects, the method may further include updating the index at the edge location with newly generated vector embeddings corresponding to newly added video assets. In some aspects, retrieving corresponding video identifiers and image URLs further includes sorting the search results based on a similarity score between the query vector embedding and the matching vector embeddings. In some aspects, the method may further include deploying a Python API wrapper to the edge location, in which the Python API wrapper encapsulates the functionality of indexing the high-dimensional vector embeddings, performing the semantic search, and returning the search results to the client application. In some aspects, the method may further include monitoring the latency and performance of the edge location and adjusting the dimensionality reduction parameters to enhance search performance and memory usage at the edge location. In some aspects, the pre-trained transformer is RoBERTa or another transformer model configured to generate high-dimensional vector embeddings from video metadata and search queries. In some aspects, the video metadata is obtained from one or more electronic program guides (EPGs) or on-demand video catalogs.

In some aspects, the method may further include displaying, at the client application, the search results including the video identifiers and image URLs, in which the image URLs are displayed as video thumbnails or posters in a user interface. In some aspects, the edge location is configured to handle multiple client applications simultaneously by balancing search requests across multiple edge nodes. In some aspects, the method may further include storing the vector embeddings and video metadata in at least one NumPy array to enhance memory usage and indexing performance at the edge location.

Further aspects may include a computing system having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a block diagram of an example network that is suitable for implementing some embodiments.

FIGS. 2A and 2B illustrate example components that could be included in a network or computing system configured to implement some embodiments.

FIGS. 3A-3C are process flow diagrams that illustrate a method of performing semantic search on video metadata at an edge location in accordance with some embodiments.

FIG. 4 is a component diagram of a system on chip (SOC) suitable for implementing some embodiments.

FIG. 5 is a component diagram of a user equipment (UE) device in the form of a laptop that is suitable for implementing some embodiments.

FIG. 6 is a component diagram of a server suitable for implementing some embodiments.

### DETAILED DESCRIPTION

The various embodiments may be described in detail with reference to the accompanying drawings. When possible, the same reference numbers may be used throughout the drawings to refer to the same or like parts. References made to particular examples and implementations are for illustrative purposes and are not intended to limit the scope of the invention or the claims.

In overview, the embodiments address various challenges of video content discovery by providing a semantic search system executed at the edge of a network. As discussed in detail below, related text-based search systems rely on exact keyword matches within video metadata, often yielding incomplete or irrelevant results. Some embodiments disclosed herein may overcome these and other limitations of related solutions by using artificial intelligence (AI) or natural language processing (NLP) models (e.g., sentence transformers, etc.) to generate high-dimensional vector embeddings that capture the semantic context of video metadata, such as descriptions, genres, or actor names. These high-dimensional vector embeddings may allow the system to process and return more contextually relevant results compared to keyword-based searches.

A distinguishing feature of some embodiments is the deployment of the semantic search system at the edge, within a content delivery network (CDN) or set-top boxes, allowing low-latency processing of user search queries. The system may acquire video metadata from sources like video-on-demand catalogs or electronic program guides (EPGs). This metadata may be pre-processed, including tasks such as “stop word removal,” conversion to lowercase, and transformation from XML to comma-separated value (CSV) format. The pre-processed data may be passed through the sentence transformer to convert textual descriptions into high-dimensional vector embeddings. Each video asset may be represented by these high-dimensional vector embeddings, which may be indexed and used to perform similarity-based searches at the edge. This configuration may reduce the load on central servers, improving scalability by supporting multiple regions without necessitating query processing at a centralized location.

A technical challenge resolved by some embodiments is linking the high-dimensional vector embeddings to the corresponding video metadata (e.g., video identifiers and image URLs, etc.) so that search results are more meaningful to end-users. The embodiment systems may also use dimensionality reduction techniques, such as artificial intelligence similarity search (AISS), to manage the computational complexity of high-dimensional vector embeddings. This may allow the system to operate efficiently on the often resource-constrained edge devices while maintaining high search accuracy.

Some embodiments may support multiple languages, such as English and Spanish, by incorporating multilingual sentence transformers that are fine-tuned for specific language tasks. As such, some embodiments may generate relevant search results regardless of the language used in the metadata or search query.

Some embodiments may enhance video content discovery by providing a context-aware, scalable, and efficient search solution that improves both latency and relevance in large-scale video libraries.

For all the above reasons, the embodiments may improve the performance and functioning of the networks and computing devices on which they are implemented. Additional improvements to the performance and functioning of the devices will be evident from the disclosures below.

The term “service provider network” is used generically herein to refer to any network suitable for providing consumers with access to the Internet or IP services over broadband connections and may encompass both wired and wireless networks/technologies. Examples of wired network technologies and networks that may be included within a service provider network include cable networks, fiber optic networks, hybrid-fiber-cable networks, Ethernet, local area networks (LAN), metropolitan area networks (MAN), wide area networks (WAN), networks that implement the data over cable service interface specification (DOCSIS), networks that utilize asymmetric digital subscriber line (ADSL) technologies, etc. Examples of wireless network technologies and networks that may be included within a service provider network include third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), high-speed downlink packet access (HSDPA), 3GSM, general packet radio service (GPRS), code division multiple access (CDMA) systems (e.g., cdmaOne, CDMA2000™), enhanced data rates for GSM evolution, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), Bluetooth®, land mobile radio (LMR), and integrated digital enhanced network (iden). Each of these wired and wireless technologies includes, for example, the transmission and reception of data, signaling and/or content messages.

Any references to terminology and/or technical details related to an individual wired or wireless communications standard or technology are for illustrative purposes only, and not intended to limit the scope of the claims to a particular communication system or technology unless specifically recited in the claim language.

The term “user equipment (UE)” may be used herein to refer to any one or all of satellite or cable set top boxes, laptop computers, rack mounted computers, routers, cellular telephones, smart phones, personal or mobile multi-media players, personal data assistants (PDAs), customer-premises equipment (CPE), personal computers, tablet computers, smart books, palm-top computers, desk-top computers, wireless electronic mail receivers, multimedia Internet enabled cellular telephones, wireless gaming controllers, streaming media players (such as, ROKU™M), smart televisions, digital video recorders (DVRs), modems, routers, network switches, residential gateways (RG), access nodes (AN), bridged residential gateway (BRG), fixed mobile convergence products, home networking adapters and Internet access gateways that enable consumers to access communications service providers'services and distribute them around their house via a local area network (LAN), and similar electronic devices which include a programmable processor and memory and circuitry for providing the functionality described herein.

The terms “component,” “system,” and the like may be used herein to refer to a computer-related entity (e.g., hardware, firmware, a combination of hardware and software, software, software in execution, etc.) that is configured to perform particular operations or functions. For example, a component may be, but is not limited to, a process running on a processor, a processor, an object, an executable, a thread of execution, a program, and/or a computing device. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process-related communication methodologies.

The term “processing system” may be used herein to refer to one or more processors, including multi-core processors, that are organized and configured to perform various computing functions. A processing system may implement various embodiment methods using one or more of its processors as described herein.

The term “system on chip” (SoC) may be used herein to refer to a single integrated circuit (IC) that contains multiple resources or independent processors integrated on a single substrate. An SoC may include digital, analog, mixed-signal, and radio-frequency circuitry, general-purpose or specialized processors (e.g., network processors, digital signal processors, modem processors, video processors, etc.), memory blocks (e.g., ROM, RAM, Flash, etc.), and other resources (e.g., timers, voltage regulators, oscillators, etc.). Examples of processors in an SoC may include central processing units (CPUs), microprocessor units (MPUs), or arithmetic logic units (ALUs), and an SoC may also include software for controlling integrated resources and peripheral devices.

The term “system in a package” (SiP) may be used herein to refer to a single module or package that contains multiple resources, computational units, cores, or processors on two or more IC chips, substrates, or SoCs. An SiP may include vertically stacked semiconductor dies or multiple ICs packaged into a unifying substrate. A SiP may also include multiple independent SoCs coupled via high-speed communication circuitry and packaged in close proximity, such as in a single motherboard or user equipment (UE).

The term “machine learning algorithm” may be used herein to refer to any computational framework used by a computing device to perform tasks, evaluate datasets, or generate predictions. Examples include neural network models, classifiers, random forest models, spiking neural networks (SNNs), convolutional neural networks (CNNs), recurrent neural networks (RNNs), deep neural networks (DNNs), generative adversarial networks (GANs), and genetic algorithm models. In some embodiments, machine learning algorithms may include architectural definitions and weights used for training and inference.

The term “neural network” may be used herein to refer to an interconnected group of processing nodes (or neuron models) that collectively perform computations to generate an inference result. Neural networks may include a variety of structures, including shallow and deep architectures, and may learn new tasks by adjusting the weight values between nodes during training.

The term “inference” may be used herein to refer to the process performed at runtime or during the execution of a software program based on a machine learning algorithm. Inference may involve traversing processing nodes in a neural network to produce an overall output or “inference result.”

The term “transformer” may be used herein to refer to a neural network model that processes input data using self-attention mechanisms. Transformers may include encoders and/or decoders to handle sequence data in parallel, allowing the model to capture contextual relationships between elements in the input. Examples of transformer models include BERT, ROBERTa, and Jinai. Transformers are often foundational components in large generative AI models (LXMs) and are used to generate high-dimensional vector embeddings that represent the semantic meaning of the input text.

The term “large generative AI model” (LXM) may be used herein to refer to advanced computational frameworks such as large language models (LLMs), large speech models (LSMs), vision language models (VLMs), and multi-modal models. LXMs may contain neural networks with millions or billions of parameters and support dialogic interactions, text summarization, translation, and complex question-answering.

The term “relevance model” may be used herein to refer to a computational unit or LXM trained to evaluate the importance or pertinence of various elements within a given dataset.

The term “sequence data processing” may be used herein to refer to techniques or models used to handle ordered sets of tokens while preserving their sequential relationships. Outputs of sequence processing may include probabilistic distributions of possible succeeding tokens.

The term “video metadata” may be used herein to refer to textual information associated with video assets, including but not limited to titles, descriptions, actor names, genres, director names, and other related metadata from sources such as electronic program guides (EPGs) or on-demand catalogs.

The term “preprocessing” may be used herein to refer to operations performed on video metadata or search queries, including but not limited to stop word removal, punctuation removal, lowercase conversion, lemmatization, and tokenization.

The term “vector embedding” may be used herein to refer to high-dimensional numerical representations of data (e.g., video metadata or search queries) that capture the semantic meaning and relationships within the data in a multi-dimensional space.

The term “query vector embedding” may be used herein to refer to a high-dimensional vector representation of a search query generated using a transformer model that is used to perform similarity-based semantic searches against indexed video metadata.

The term “dimensionality reduction” may be used herein to refer to techniques for reducing the number of dimensions in vector embeddings while preserving key semantic relationships, including but not limited to Principal Component Analysis (PCA) and scalar quantization.

The term “scalar quantization” may be used herein to refer to a data compression technique used to reduce the size of vector embeddings by converting numerical values to lower precision representations, such as 8-bit or 16-bit quantization.

The term “indexing” may be used herein to refer to the process of organizing and storing vector embeddings along with corresponding video identifiers and image URLs, allowing efficient retrieval of relevant video assets during a semantic search.

The term “artificial intelligence similarity search” (AISS) may be used herein to refer to a similarity-based indexing and search library that is used for efficiently handling high-dimensional vector embeddings and performing similarity-based searches.

The term “edge location” may be used herein to refer to a remote computing location, including but not limited to content delivery networks (CDNs) or set-top boxes, in which semantic search functionality is deployed to reduce latency and enhance search performance.

The term “semantic search” may be used herein to refer to a type of search that returns results based on the contextual and semantic meaning of the input query, as opposed to simple keyword matching, by using vector embeddings and similarity metrics.

The term “cosine similarity” may be used herein to refer to a metric used to measure the similarity between two vector embeddings in a high-dimensional space based on the cosine of the angle between them and commonly used in semantic search systems.

The term “video identifiers” or “Tribune Media Services Identifier” (TMS-ID) may be used herein to refer to unique identifiers assigned to video assets, which may be used to link vector embeddings to corresponding video metadata and image URLs.

The term “image URL” may be used herein to refer to a link or reference to an image, such as a thumbnail or poster, associated with a video asset that is returned as part of the search results.

The term “client application” may be used herein to refer to a software application, such as a video streaming or content discovery application, that interacts with the semantic search system to submit search queries and retrieve search results.

The term “search query” may be used herein to refer to an input provided by a user or client application, which contains information about the video asset being searched, such as the title, actor name, genre, or description, and is used to perform a semantic search.

The term “parallel arrays” may be used herein to refer to data structures that store video metadata and corresponding vector embeddings in a manner that maintains index alignment between the two, allowing efficient retrieval of metadata based on vector embedding matches.

The term “deduplication” may be used herein to refer to the process of removing duplicate search results during a semantic search, particularly when multiple vector embeddings correspond to the same video asset.

The term “low-latency search” may be used herein to refer to a search process that delivers results with minimal delay by deploying the semantic search functionality at edge locations close to the end users to reduce network and processing latencies.

The term “principal component analysis (PCA)” may be used herein to refer to a dimensionality reduction technique used to reduce the number of dimensions in vector embeddings while preserving essential semantic information.

The term “natural language processing (NLP)” may be used herein to refer to machine learning techniques, including transformer models, that process and understand human language by converting text into semantic representations such as vector embeddings.

The term “API wrapper” may be used herein to refer to a software interface that encapsulates the functionality of processing search queries, generating vector embeddings, performing similarity-based searches, and retrieving video metadata.

The term “similarity score” may be used herein to refer to a numerical value that represents the degree of similarity between a query vector embedding and a video metadata vector embedding, typically based on cosine similarity, and is used to rank search results.

The term “set-top box” (STB) may be used herein to refer to an edge computing device that is deployed in a content delivery network (CDN) or at a user's premises, allowing the execution of low-latency semantic search functionality.

The term “electronic program guide” (EPG) may be used herein to refer to a source of video metadata that provides information about broadcast or on-demand video content, including but not limited to program titles, descriptions, schedules, and associated metadata.

Content discovery systems are platforms that help users find and access digital media across various formats. They organize, filter, and recommend content based on user preferences, search queries, or past interactions. Through algorithms and databases, users may browse or search for media—such as movies, music, books, or articles—by title, genre, or artist. These content discovery systems are important to online platforms and streaming services and offer users personalized experiences while navigating large digital libraries.

Video content discovery systems are a specialized subset of content discovery systems focused on helping users find video-based media, such as movies, TV shows, and other visual content. These video content discovery systems are commonly integrated into streaming services like Netflix®, Amazon Prime Video®, and Hulu®, which use advanced algorithms to recommend content based on a user's viewing history and preferences. These video content discovery systems offer personalized recommendations by analyzing metadata, user behavior, and viewing patterns.

Video content discovery systems are typically deployed on streaming platforms, video-on-demand services, and set-top boxes. These video content discovery systems offer search functions, recommendations, and curated lists to facilitate easy browsing. They rely heavily on metadata—such as titles, descriptions, genres, and actors—to match user queries with relevant content. As digital media becomes more complex and video libraries expand, advanced discovery systems are becoming more important for finding relevant content based on preferences or context.

Related video content discovery systems rely on keyword-based searches that match exact terms in metadata with user queries. While sufficient for basic searches, these systems are inadequate for understanding deeper relationships between search terms and video content and often produce irrelevant or incomplete results. These limitations have driven the development of more sophisticated systems that incorporate machine learning and natural language processing to improve recommendation accuracy and help users find content that better aligns with their search intent.

Related video content discovery systems may be limited because they rely on keyword-based search methods that match exact words or phrases in metadata. These related video content discovery systems do not capture the semantic meaning or contextual relationships between terms, often resulting in less relevant search results. As video catalogues continue to grow, encompassing various metadata fields like titles, descriptions, actors, and genres, managing the complexity of this data while achieving low-latency performance becomes increasingly difficult. Server-side searches often lead to delays caused by network congestion and increased latency that negatively impact the user experience. In addition, managing the high-dimensional vector embeddings produced by advanced models presents storage and computational challenges, particularly when operating at edge locations with constrained resources.

Related video content discovery systems typically rely on centralized, server-based architectures that perform keyword searches on structured databases. While capable of managing basic queries, they often fail to grasp the contextual meaning of user queries, delivering irrelevant or incomplete results. Centralized search functions may also introduce latency since user requests may be required to travel across multiple network nodes.

Some related video content discovery systems attempt to improve performance through caching or enhanced query execution, but these approaches do not address the core issue of limited semantic understanding. They also struggle to manage the high-dimensional data generated by machine learning models, leading to performance bottlenecks, particularly when processing large-scale metadata collections, thus limiting their ability to scale and deliver relevant content efficiently.

The embodiments disclosed herein overcome these and other limitations of related content discovery systems by using transformer models to perform semantic searches on video metadata at edge locations. The embodiments disclosed herein may generate more relevant search results by converting video metadata into high-dimensional vector embeddings that capture the semantic meaning and context of the data. The embodiments may provide indexing and search functionality at edge locations (e.g., STBs or edge computing platforms within a CDN, etc.) to reduce network latency and allow for faster response times. The embodiments disclosed herein may move the search functionality closer to the end-users to eliminate or reduce the delays typically associated with server-based systems.

Some embodiments disclosed herein may use dimensionality reduction techniques (e.g., PCA, scalar quantization, etc.) to reduce the storage and computational requirements for high-dimensional vector embeddings. These enhancements may allow the system to operate efficiently, even on resource-constrained edge devices. Some embodiments may also include an intelligent indexing system that is capable of performing similarity-based searches using AISS tools (e.g., FAISS, etc.) so that the search results are both relevant and scalable. Some embodiments may combine these features to provide a comprehensive solution to the technical challenges of related content discovery systems to improve the performance, relevance, and scalability of video content discovery.

In some embodiments, the processing system of a computing device may be configured to receive video metadata associated with one or more video assets from at least one metadata source. The processing system may preprocess the video metadata by removing stop words, punctuation, and irrelevant terms. The processing system may convert the metadata to lowercase and perform lemmatization to standardize word forms. The processing system may convert the preprocessed video metadata into high-dimensional vector embeddings using a pre-trained transformer. The processing system may index the high-dimensional vector embeddings along with corresponding video identifiers and image URLs in an index so that each high-dimensional vector embedding corresponds to one or more metadata fields of the video metadata. The embodiments may deploy the index to an edge location within a CDN or an edge computing platform, making the data available for efficient semantic search.

At the edge location, the processing system may receive a semantic search query from a client application. Upon receiving the query, the system may pre-process the search query by removing stop words, punctuation, and irrelevant terms, converting the query to lowercase, and performing lemmatization to standardize the input. The system may convert the preprocessed search query into a query vector embedding using the pre-trained transformer and search the index using the query vector embedding. This process may retrieve one or more matching vector embeddings corresponding to the video metadata. Based on the matching vector embeddings, the processing system may retrieve the corresponding video identifiers and image URLs associated with the relevant video assets and return these to the client application as search results.

In some embodiments, the processing system may further preprocess the video metadata by parsing it into one or more metadata fields, such as a title, description, actor, or genre. Each metadata field may then be processed individually, with the system generating a separate high-dimensional vector embedding for each metadata field associated with the video metadata. These high-dimensional vector embeddings, along with the corresponding video metadata, may be stored in a structured format that maintains index alignment between the video metadata and the high-dimensional vector embeddings, ensuring efficient retrieval during semantic searches.

The pre-trained transformer used in the processing system may be a BERT-based model configured to convert both video metadata and search queries into high-dimensional vector embeddings. Before indexing the vector embeddings at the edge location, the processing system may perform dimensionality reduction to enhance the high-dimensional vector embeddings. This dimensionality reduction may include techniques such as Principal Component Analysis (PCA) or scalar quantization to reduce the size and complexity of the embeddings. Scalar quantization, for example, may involve applying 8-bit or 16-bit quantization to reduce the memory and storage requirements of the embeddings at the edge location, thereby improving storage efficiency.

When indexing the high-dimensional vector embeddings, the processing system may use a similarity-based search index, such as FAISS, to efficiently manage high-dimensional vector embeddings and enable similarity-based searches. The semantic search query may be transmitted to the edge location from a client device, such as a video streaming or content discovery application. The processing system may also perform deduplication of the search results to eliminate duplicate entries that result from multiple vector embeddings corresponding to the same video asset.

In some embodiments, the edge location may be a set-top box or an edge computing device deployed within a content delivery network. The index at the edge location may be updated with newly generated vector embeddings corresponding to newly added video assets so that the index remains current. The processing system may further sort the search results based on a similarity score between the query vector embedding and the matching vector embeddings (i.e., to provide the most relevant results to the client application).

In some embodiments, the processing system at the edge location may deploy a Python API wrapper that encapsulates the functionality of indexing the high-dimensional vector embeddings, performing the semantic search, and returning the search results to the client application. The system may monitor the latency and performance of the edge deployment and adjust the dimensionality reduction parameters as needed to enhance search performance and memory usage at the edge location.

The pre-trained transformer used by the processing system may be one or more models selected from BERT, ROBERTa, or other transformer models configured to generate high-dimensional vector embeddings from both video metadata and search queries. The video metadata processed by the system may be obtained from one or more sources, including electronic program guides (EPGs) or on-demand video catalogs.

In some embodiments, the client application may display the search results, including video identifiers and image URLs, with the image URLs displayed as video thumbnails or posters within a user interface, allowing for intuitive browsing and content discovery. The edge location may be configured to handle multiple client applications simultaneously by balancing search requests across multiple edge nodes, providing scalable and efficient performance. To further enhance memory usage and indexing performance, the processing system may store the vector embeddings and video metadata in one or more NumPy arrays.

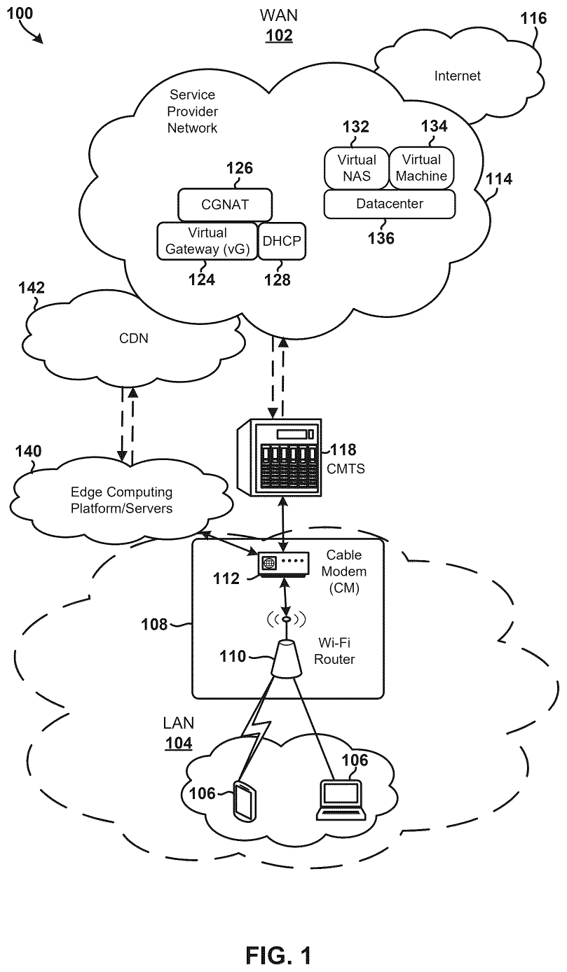

FIG. 1 illustrates a simplified example of a network 100 suitable for implementing an edge-based semantic video metadata search system in accordance with some embodiments. FIG. 1 provides a high-level overview of the network architecture and relevant connectivity paths for deploying search functionality closer to end-users via edge computing platforms. As such, it should be understood that FIG. 1 is not intended to detail every specific connection or physical layout but to provide a conceptual understanding of the network components that support the integration of the edge-based semantic search system into a video streaming architecture.

With reference to FIG. 1, the network configuration may include a wide area network (WAN) 102 and a local area network (LAN) 104. User equipment (UE) 106, such as smartphones, tablets, and laptops, may communicate with customer premise equipment (CPE) 108 that facilitates connectivity to edge computing resources 140, including the edge computing platform 140 that hosts the search system. The CPE 108 may include a Wi-Fi router 110 and a cable modem (CM) 112 that connect the UE 106 to edge computing platform 140 and the service provider's content delivery network (CDN) 142 over the WAN 102. The edge computing platform 140 may host important components of the semantic search system to allow for low-latency processing of search queries at the network edge. CPE 108 may support network traffic between the local UE 106 and the edge platform to reduce the need to send search queries to central servers located further away in WAN 102.

The cable modem termination system (CMTS) 118 may provide network connectivity between the CPE 108 and the service provider network 114 so that search requests and video metadata from the UE 106 reach the appropriate edge-based semantic search system.

The network may also include virtualized components such as virtual machines (VM) 134 and virtual network-attached storage (NAS) 132 in a data center 136, which may be part of the service provider's network. These virtualized systems may provide additional back-end support for indexing video metadata and managing large-scale databases, although most real-time search operations may be handled at the edge.

An edge computing platform may process search queries locally by hosting the search system's key modules, such as the metadata vectorization and indexing modules, which convert metadata into vector embeddings and retrieve relevant search results for the user. The service provider network 114, part of the WAN 102, may manage the connection between edge servers and central resources, including handling updates to the indexed data periodically sent to the edge.

In this configuration, the UE 106 sends search queries to the edge platform via the Wi-Fi router 110. The edge platform processes the query, converts it into vector embeddings, and performs a semantic similarity search on the indexed video metadata. The relevant search results, including video identifiers and associated metadata, are then returned to the UE for content discovery and browsing.

The virtual gateway (vG) 124 and other components such as dynamic host configuration protocol (DHCP) 128 may manage IP address assignments and traffic between the CPE and the edge platform. However, the primary focus remains on optimizing the search performance at the edge to reduce response times and enhance user interaction with video content.

In some embodiments, in instances in which the edge computing platform 140 is unavailable or unable to process a search request due to resource constraints or system failures, the network may implement a fallback mechanism to route the search request to backend resources in the data center 136. This fallback path may allow for continued operation and search functionality by, for example, using VM 134 and virtual NAS 132 to process search queries and retrieve relevant video metadata. When this occurs, the request from the UE 106 is forwarded through the WAN 102 and service provider network 114, bypassing the edge servers. The backend resources in the data center 136 may then perform the necessary vectorization, indexing, and semantic similarity search operations, returning the results to the UE 106. Such fallback systems may introduce higher latency due to the increased distance between the UE and the backend infrastructure.

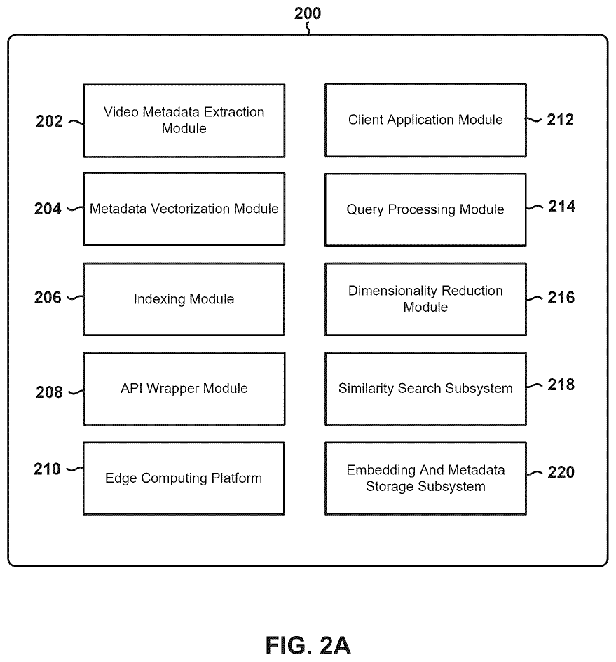

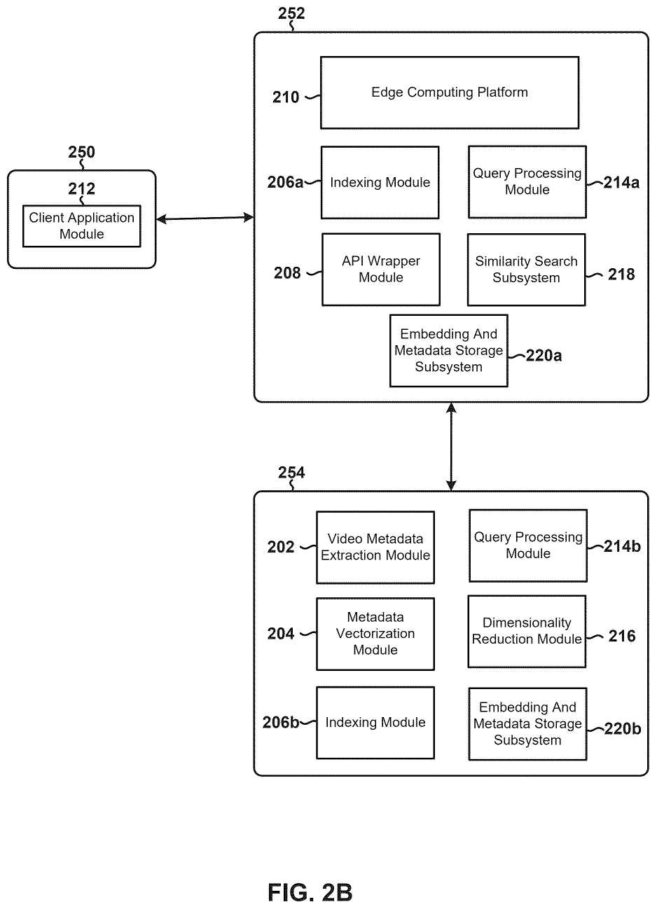

FIG. 2A is a component block diagram illustrating example components that could be included in a semantic video metadata search system 200 configured to perform a semantic search on video metadata at an edge location in accordance with some embodiments. In the example illustrated in FIG. 2, the semantic video metadata search system 200 includes a video metadata extraction module 202, a metadata vectorization module 204, an indexing module 206, an API wrapper module 208, an edge computing platform 210, a client application module 212, a query processing module 214, a dimensionality reduction module 216, a semantic similarity search subsystem 218, and an embedding and metadata storage subsystem 220. In various embodiments, any portion or all of any of the components 202-220 may be implemented in an edge server, a backend server, or a user device.

The video metadata extraction module 202 may be configured to retrieve and process video metadata from a variety of sources, including EPGs, video-on-demand catalogs, and other content databases. This metadata may include information such as titles, descriptions, genres, actors, and other relevant textual data associated with video content. The video metadata extraction module 202 may preprocess the metadata by normalizing formats, removing stop words, and standardizing the text to improve downstream processing.

The metadata vectorization module 204 may be configured to convert the extracted video metadata into high-dimensional vector embeddings. The metadata vectorization module 204 may use NLP models, LXMs, transformers, etc. to generate semantic representations of the metadata. These vector embeddings may capture the contextual and semantic meaning of the video metadata for more relevant and context-based searches.

The indexing module 206 may be configured to organize and store the vector embeddings generated by the metadata vectorization module 204, along with corresponding video identifiers (e.g., TMS-ID, etc.) and image URLs. The indexing system may use data structures optimized for fast retrieval, such as hash maps or specialized libraries like AISS, to allow efficient semantic similarity search operations on the vector embeddings during query processing.

The API wrapper module 208 may be configured to encapsulate the functionality of the various modules within the semantic video metadata search system 200. The API wrapper module 208 may expose an interface that allows external systems, such as client applications, to interact with the search system by submitting search queries, receiving search results, and managing metadata indexing. The API wrapper module 208 may also convert query data into the appropriate format for processing within the edge computing environment.

The edge computing platform 210 may be configured to deploy and execute the core components of the semantic video metadata search system 200 at edge locations. By hosting the search system closer to end-users, the edge computing platform allows for low-latency search query processing and faster response times. The platform may manage resource allocation, task scheduling, and communication between the search system modules and external network components such as CDNs, UEs, and user devices.

The client application module 212 may be configured to interface with the semantic search system 200 from UEs or user devices, such as video streaming applications. This client application module 212 may send search queries to the edge computing platform and receive video identifiers and metadata for content discovery. The client application module 212 may also handle user interaction for the integration of semantic search results into the user interface for browsing and viewing content.

The query processing module 214 may be configured to handle incoming search queries from client applications. This module may convert the query text into vector embeddings using the same NLP models (or LXMs, transformers, etc.) as the metadata vectorization module 204. The query processing module 214 may perform a semantic similarity search on the indexed video metadata to identify and rank the most relevant results based on semantic meaning. The query processing module 214 may also filter, refine, or rank search results based on additional parameters, such as user preferences or contextual data.

The dimensionality reduction module 216 may be configured to reduce the size of the high-dimensional vector embeddings to enhance performance in the search system. Techniques such as Principal Component Analysis (PCA), t-SNE, or other compression methods may be used to maintain the essential semantic relationships within the data while reducing memory and computational requirements, particularly for deployment in resource-constrained edge environments.

The semantic similarity search subsystem 218 may be configured to execute the core search functionality of the system. The semantic similarity search subsystem 218 may perform similarity matching between the query vector embeddings and the indexed video metadata embeddings to identify the closest matches based on semantic meaning. The semantic similarity search subsystem 218 may use specialized libraries or algorithms like AISS to efficiently perform nearest-neighbor searches in high-dimensional vector spaces.

The embedding and metadata storage subsystem 220 may be configured to store the vector embeddings generated by the metadata vectorization module 204, as well as the corresponding video metadata. This subsystem may use efficient data storage techniques, such as NumPy arrays or databases, to provide fast access to the indexed data. In addition, the embedding and metadata storage subsystem 220 may support synchronization with backend systems or cloud storage to ensure that the indexed data remains up-to-date and consistent across multiple edge locations.

FIG. 2B is a component block diagram that illustrates that any portion or all of any of the components 202-220 may be implemented in a user device 250, an edge server 252, and a backend server 254. With reference to FIGS. 1-2B, the user device 250 includes the client application module 212, the edge server 252 includes the metadata vectorization module 204, indexing module 206, AIP wrapper module 208, edge computing platform 210, a query processing module 214, dimensionality reduction module 216, a semantic similarity search subsystem 218, and an embedding and metadata storage subsystem 220. The backend server 254 includes a video metadata extraction module 202, metadata vectorization module 204, indexing module 206b, query processing module 214b, dimensionality reduction module 216, and an embedding and metadata storage subsystem 220b.

FIG. 2B is a component block diagram that illustrates how various components of the semantic video metadata search system 200 may be distributed across different types of devices in a network, including a user device 250, an edge server 252, and a backend server 254. In particular, FIG. 2B demonstrates that the components 202-220 may be distributed across a hybrid architecture in which the edge computing device handles real-time, low-latency processing and backend systems manage large-scale data operations to provide support for more computationally intensive tasks.

With reference to FIGS. 1 and 2B, the user device 250 (e.g., a smartphone, tablet, STB, etc.) may include the client application module 212. This client application module 212 may serve as the interface between the user and the semantic search system. The client application module 212 may be responsible for sending search queries to edge server 252 and receiving results, such as video identifiers and associated metadata, to display content or search results to the user.

The edge server 252 may include several of the components of the semantic video metadata search system, including indexing module 206a (which indexes these vector embeddings and corresponding video identifiers for fast retrieval of relevant video metadata), API wrapper module 208 (which exposes an interface allowing external systems, such as the client application module 212, to interact with the search system by sending queries and receiving results), edge computing platform 210 (which processes search queries locally to reduce latency and deliver faster search results to end-users), query processing module 214a (which handles the actual query input, converting it into vector embeddings and performing semantic similarity searches on the indexed data), semantic similarity search subsystem 218 (which identifies and ranks the most relevant search results by comparing query embeddings to indexed embeddings) and embedding and metadata storage subsystem 220a (which stores the vector embeddings and corresponding metadata for efficient access).

The backend server 254 may include components that support large-scale processing and storage, including the video metadata extraction module 202 (which is responsible for gathering and preprocessing video metadata from various sources), the metadata vectorization module 204 (which converts video metadata into high-dimensional vector embeddings that capture semantic meaning), indexing module 206b (which organizes and stores large quantities of vector embeddings and corresponding video metadata for use across multiple edge locations), query processing module 214b (which may assist in processing complex queries or act as a fallback in case the edge server is unavailable), dimensionality reduction module 216 (which enhances the high-dimensional data for storage and retrieval), and embedding and metadata storage subsystem 220b (which stores embeddings and metadata in a backend environment, providing a central repository that may synchronize with multiple edge servers).

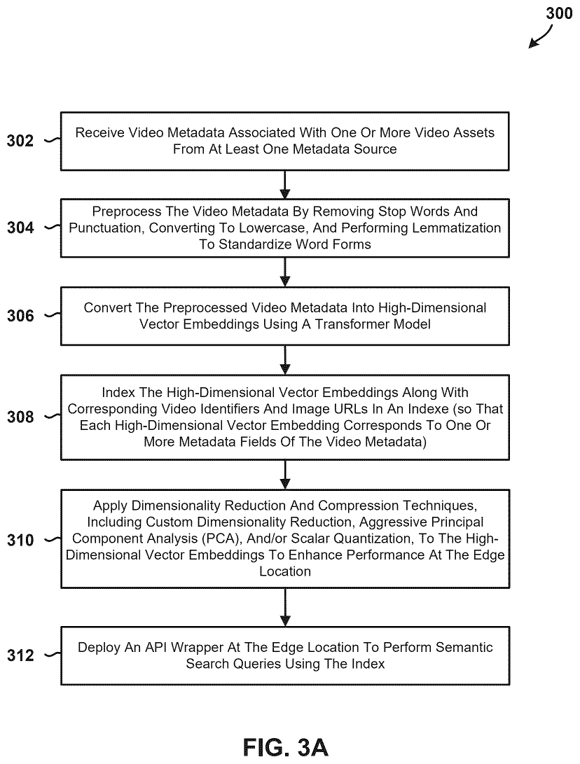

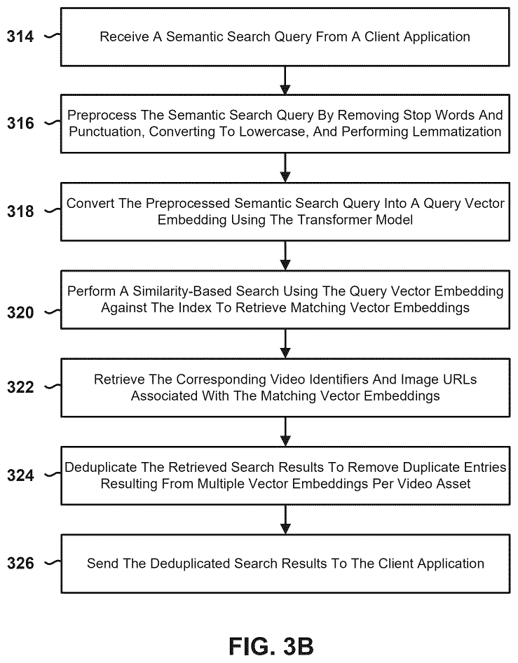

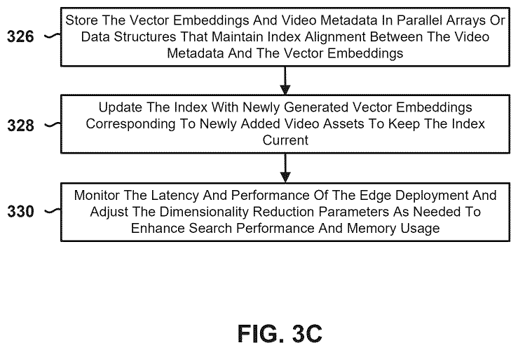

FIGS. 3A-3C are process flow diagrams illustrating a method 300 of executing semantic video metadata search at edge locations in a network communication system in accordance with some embodiments. With reference to FIGS. 1-3C, method 300 may be performed by a computing device at an edge location by a processing system encompassing one or more components or subsystems discussed in this application. Means for performing the functions of the operations in method 300 may include a processing system including one or more processors and other components described herein. Further, one or more processors of a processing system may be configured with software or firmware to perform some or all of the operations of method 300. To encompass the alternative configurations enabled in various embodiments, the hardware implementing any or all method 300 is referred to herein as a “processing system.”

Referring to FIG. 3A, and with reference to FIGS. 1-3A, in block 302, the processing system may receive video metadata associated with one or more video assets from at least one metadata source, which may include structured databases such as EPGs or CMSs. The processing system may obtain the video metadata from sources including EPGs, on-demand video catalogues, or other metadata sources. For example, the processing system may query an EPG provided by a broadcast network to retrieve metadata such as the title, air time, genre, description, and cast information for scheduled TV shows and movies. This metadata may then be processed and indexed to support context-based search queries.

The processing system may also retrieve metadata from a Video-on-Demand (VOD) catalog, which extracts information such as the movie or series title, synopsis, release date, director, and actors. This data may come from streaming platforms like Netflix or Hulu, and could include additional details like user ratings, language availability, and content tags. For example, metadata for a video asset might include a title like “AI world,” a description of the video, the names of the actors, the release year, and relevant keywords such as “technology” or “innovation.”

In another example, the processing system may connect to a content management system (CMS) used by a video streaming service to retrieve metadata for uploaded or hosted content. This metadata may include user-generated tags, video categories, view counts, or additional descriptive text provided by the content creators. For example, the processing system may extract metadata for a tutorial video that has the title “How to Code in 10 Minutes,” along with tags such as “HTML,” “web development,” and “coding.”

Further, the processing system may interface with a user-generated content platform like YouTube or Vimeo to obtain metadata directly from content creators. This could include custom titles, descriptions, categories, thumbnails, and tags assigned by the video uploader. For example, for a fitness tutorial video, the metadata may include the title “Workout Routine,” along with tags like “exercise,” “health,” and “training.”

In each of the above examples, the video metadata gathered by the processing system serves as the foundation for indexing and vectorizing the assets, ultimately allowing the semantic search functionality that allows users to discover video content based on the meaning and context of their queries.

In block 304, the processing system may preprocess the video metadata by removing stop words and punctuation, converting to lowercase, and performing lemmatization to standardize word forms. For example, the processing system may perform lemmatization, which reduces words to their base form. For example, a description that includes the phrase “running complex algorithms” would be lemmatized to “run complex algorithm.” This process allows different variations of a word (e.g., run, running, and ran) to be treated as the same term, improving the accuracy of the search results by using a consistent base form to represent all related words.

In some embodiments, the processing system may be configured to handle multiple vector embeddings per video asset corresponding to different metadata fields such as title, description, actor, genre, director, and rating. Handling multiple vector embeddings per video asset may allow the system to maintain distinct representations for each metadata field (e.g., title, genre, etc.), thus enhancing search granularity. Each metadata field may provide unique contextual information about the video, which may be represented by a separate vector embedding to capture its specific semantic meaning. For example, the title of a movie might reflect its overall theme, while the description could offer detailed plot information, and the genre might indicate its category (e.g., comedy, drama).

By generating distinct vector embeddings for each field, the system may process and index these different aspects of the video separately, allowing for more accurate and granular searches. For example, a user searching for “sci-fi movies directed by Steven Spielberg” would benefit from embeddings generated for both the genre (“sci-fi”) and director (“Joe Spielberg”), allowing the system to precisely match videos that satisfy both criteria.

Further, the processing system may manage these multiple embeddings during the preprocessing stage by identifying which metadata fields are relevant and generating corresponding embeddings. During the indexing step, these embeddings may be stored in alignment with their associated metadata fields so that the system may efficiently perform searches across multiple dimensions, such as matching both title and genre simultaneously. For example, a video titled “The Future of AI” may have a vector embedding for the title “The Future of AI” and another for its description (“A documentary on the rise of artificial intelligence”), ensuring that a search for either “AI” or “artificial intelligence” can return the relevant video. This may allow the system to respond to more complex and semantically rich queries to improve the overall relevance of search results.

In some embodiments, the preprocessing may include removing irrelevant terms and performing tokenization to prepare the video metadata and search queries for vectorization.

In block 306, the processing system may convert the preprocessed video metadata into high-dimensional vector embeddings using a transformer model. For example, the processing system may use models such as Bidirectional Encoder Representations from Transformers (BERT), ROBERTa, or Jinai models to capture the semantic and contextual relationships in the video metadata and search queries. These transformer models may analyze the metadata fields (e.g., title, description, actor, genre) and generate vector embeddings that represent the meaning and context of each field in a high-dimensional space.

The transformer model may also incorporate pre-trained embeddings, enabling the system to leverage prior knowledge of language structures and domain-specific terms (e.g., “AI” and “machine learning”) to improve the quality and relevance of the vector embeddings. Pre-trained embeddings may capture contextual relationships in language, allowing the system to recognize domain-specific terms. Pre-trained models such as BERT are typically fine-tuned for specific tasks like semantic search.

In some embodiments, the processing system may be configured to apply scalar quantization in block 306 by reducing the vector embeddings to lower precision representations, including 8-bit or 16-bit quantization, to improve or reduce storage and memory usage at the edge location.

In block 308, the processing system may index the high-dimensional vector embeddings along with corresponding video identifiers and image URLs in an index so that each high-dimensional vector embedding corresponds to one or more metadata fields of the video metadata. For example, the processing system may generate a separate vector embedding for the title, description, genre, and actor fields of a video asset. These embeddings may be stored in the index along with the video identifier (e.g., a TMS ID) and an image URL (e.g., a thumbnail or poster image).

For instance, if the metadata for a video includes the title “The Future of AI,” a description “A documentary on artificial intelligence,” and the genre “Documentary,” the system generates vector embeddings for each of these fields. Each vector embedding may capture the semantic meaning of the corresponding metadata field and is indexed alongside the unique video identifier and the associated image URL.

By indexing the embeddings with their corresponding metadata fields, the system ensures that when a user performs a search (e.g., for “documentaries on AI”), the query is compared against the embeddings in the index. The index facilitates fast retrieval of the most relevant results by matching the query's vector embedding with the indexed embeddings of titles, descriptions, or genres, ultimately returning results such as “The Future of AI,” along with the video's identifier and thumbnail for display. This allows for a more efficient similarity-based search across multiple metadata dimensions.

In some embodiments, the indexing operations may include using specialized data structures and indexing techniques, including NumPy arrays or AISS, to allow efficient similarity-based searches in high-dimensional vector spaces.

In block 310, the processing system may apply dimensionality reduction and compression techniques, including custom dimensionality reduction, aggressive principal component analysis (PCA), and/or scalar quantization, to the high-dimensional vector embeddings to enhance performance at the edge location. For example, the processing system may use PCA to reduce the dimensionality of vector embeddings from 1024 dimensions to 128 dimensions while preserving the essential semantic information. In addition, the processing system may apply scalar quantization, reducing the precision of the vector embeddings by encoding them as 8-bit or 16-bit values. For example, instead of using full 32-bit floating-point precision for each vector component, the system may quantize the embeddings to 8-bit, significantly reducing the storage footprint without substantial loss of accuracy in the semantic similarity search. This may allow the system to store more embeddings in the limited memory available at edge locations, such as on set-top boxes or CDN servers.

In some embodiments, the dimensionality reduction techniques may include t-distributed stochastic neighbor embedding (t-SNE) applied before indexing. For example, the processing system may use t-SNE to reduce the high-dimensional vector embeddings generated from video metadata (such as title, description, and genre) to a lower-dimensional space (e.g., 2 or 3 dimensions), while preserving the local relationships between similar data points.

For example, if the processing system generates 1024-dimensional vector embeddings for multiple video assets, t-SNE may reduce these embeddings to a lower dimension while maintaining the relative distances between embeddings that represent similar video content. This may allow videos with similar metadata (e.g., two documentaries about artificial intelligence) to remain close together in the reduced dimensional space, which may improve the system's ability to perform similarity-based searches.

By applying t-SNE before indexing, the system may visualize complex patterns in the data and improve the clustering of similar embeddings to deliver more accurate and relevant search results. In addition, t-SNE may aid in reducing the overall memory footprint and computational costs at the edge location.

In block 312, the processing system may deploy an API wrapper at the edge location to perform semantic search queries using the index. The API wrapper may serve to operate as the interface between the client application, such as a video streaming app, and the underlying search system. The API wrapper may standardize the interaction between the client application and edge server. By positioning the wrapper at the edge, the system may provide lower latency, faster query processing, and more efficient response times.

The API wrapper, which may be a Python API wrapper or an EmbeddingAPI, may convert user queries into vector embeddings using transformer models like BERT or ROBERTa. It then performs a semantic similarity search against the indexed vector embeddings to identify relevant video assets. Once the API wrapper finds matching embeddings, it retrieves the corresponding video identifiers, image URLs, and metadata from the index and returns them to the client application.

While Python is commonly used due to its robust libraries and ease of integration, the API wrapper may also be built in Java, C++, or JavaScript to suit specific deployment environments. By handling these operations at the edge, the system delivers fast and relevant search results with minimal reliance on centralized servers.

In various embodiments, the API wrapper may be a Python API wrapper or an EmbeddingAPI that encapsulates functionalities such as converting query information into vector embeddings, querying the vector index, retrieving relevant video matches, and returning associated metadata to the client application. The API wrapper may be implemented in Python or built using other programming languages such as Java, C++, or JavaScript to suit the deployment environment.

Referring to FIG. 3B, and with reference to FIGS. 1-3B, in block 314, the processing system may receive a semantic search query from a client application, which may be a video streaming or content discovery application that communicates with the edge location to execute semantic searches on the video metadata. For example, the processing system may receive a user query like “sci-fi movies about AI” from a streaming app.

In block 316, the processing system may preprocess the semantic search query by removing stop words and punctuation, converting to lowercase, and performing lemmatization. For example, the processing system may take a query such as “AI in Sci-Fi Films” and remove common words like “in” and “films,” convert “Sci-Fi” to lowercase as “sci-fi,” and lemmatize “films” to its base form, “film.” The result may be a simplified query (e.g., “AI sci-fi film”) that may be processed more efficiently by the transformer model.

In block 318, the processing system may convert the preprocessed semantic search query into a query vector embedding using the transformer model. For example, the processing system may apply BERT or ROBERTa to the cleaned query “AI sci-fi film” to generate a high-dimensional vector embedding. This embedding may capture the semantic meaning of the query so that the system may compare it with the video metadata stored in the index.

In block 320, the processing system may perform a similarity-based search using the query vector embedding against the index to retrieve matching vector embeddings. For example, the system may compare the “AI sci-fi film” query embedding with the indexed embeddings of various video assets to identify content with similar themes, such as movies with AI-related plots in the sci-fi genre. The system may look for the closest matches based on the semantic similarity between the query embedding and the metadata embeddings in the index.

In some embodiments, the processing system may be configured to use machine learning algorithms to perform similarity-based searches. The processing system may calculate similarity scores based on cosine similarity between the query vector embedding and the indexed vector embeddings. For example, the system may calculate the cosine similarity between the “AI sci-fi film” query embedding and video metadata embeddings such as “The Rise of AI” or “Future Tech in Sci-Fi.” Higher similarity scores may indicate a closer match. In some embodiments, the system may rank the results in terms of relevance.

In block 322, the processing system may retrieve the corresponding video identifiers and image URLs associated with the matching vector embeddings. For example, after identifying “The Rise of AI” as a relevant result, the system retrieves its video identifier (e.g., VID12345) and its thumbnail image URL (e.g., http://example.com/thumbnails/VID12345.jpg). This information may allow the client application to display the matching videos and their associated metadata to the user. This allows the metadata and media assets to remain aligned with the high-dimensional vector embeddings, which may, in turn, improve the search results.

In block 324, the processing system may deduplicate the retrieved search results to remove duplicate entries resulting from multiple vector embeddings per video asset. For example, if a video asset has several vector embeddings representing different metadata fields such as title and description, the system may detect that “The Rise of AI” has multiple embeddings and remove redundant entries. This may help ensure that the user only sees a single result for the same video, even if it matches multiple aspects of the search query. For example, if both the title and description embeddings match the query, the system may merge these results into one to avoid duplicates in the displayed results.

Referring to FIG. 3C, and with reference to FIGS. 1-3C, in block 326, the processing system may return the deduplicated search results to the client application. In some embodiments, the search results, including video identifiers and image URLs, may be displayed as video thumbnails or posters within a user interface of the client application. For example, in instances in which the query returned “The Rise of AI,” the user may see the video thumbnail along with its relevant metadata, such as the title, description, and video identifier, presented in an organized and visually appealing layout.

In block 328, the processing system may store the vector embeddings and video metadata in parallel arrays or data structures that maintain index alignment between the video metadata and the vector embeddings. This allows each video asset's metadata fields (such as title, description, and genre) to be properly aligned with their corresponding vector embeddings and/or allows for efficient search and retrieval operations during future queries.

In block 330, the processing system may update the index with newly generated vector embeddings corresponding to newly added video assets to keep the index current. For example, when a new video asset is added to the platform, its metadata may be preprocessed, vectorized, and indexed alongside the existing content so that the system may quickly retrieve and display new videos in response to relevant search queries.

In block 332, the processing system may monitor the latency and performance of the edge deployment and adjust the dimensionality reduction parameters as needed to enhance search performance and memory usage. For example, if the system detects higher latency due to increased traffic, it may apply more aggressive dimensionality reduction techniques, such as PCA or scalar quantization, to improve the performance while maintaining the accuracy of the search results.

The semantic video metadata search system disclosed in this application may use recent advancements in NLP, specifically the use of sentence transformers, to enable context-based searches for video content. Traditional text-based search methods rely on exact text matching, which limits the relevance of search results. In contrast, this system uses semantic search that allows users to query video content based on the context and meaning of their search terms. The system converts video metadata, such as titles, descriptions, genres, and actor names, into high-dimensional vector embeddings, representing the semantic meaning of the metadata in a vector space. These vector embeddings are then indexed and used to perform similarity-based searches at the edge of the network, significantly improving the accuracy and relevance of search results.

The sentence transformer model may process the video metadata and generate vector embeddings ranging from 512 to 1024 dimensions. While more advanced models can reach up to 15,382 dimensions, for the purposes of this video metadata search, a 1024-dimensional representation may be adequate. These vector embeddings may be processed and stored efficiently using techniques such as Facebook's FAISS, which reduces the dimensionality of the embeddings and enables faster search performance. This reduction is important for edge deployments, where computational and memory resources may be limited. FAISS allows the system to index and search these high-dimensional embeddings while maintaining the accuracy needed for context-based search results.

The system may be deployed at the edge, such as on CDNs or set-top boxes. By processing search queries closer to the end-user, the system may significantly reduce latency to provide low-latency search results without the need to send queries back to a central server. This distributed architecture may improve scalability, allowing the system to handle search queries from multiple regions simultaneously without overloading backend servers. Additionally, this architecture provides greater scalability, as the system can handle multiple edge nodes to balance search requests from various client applications.

When performing the metadata processing, the system may begin by extracting video metadata from various sources, including electronic program guides (EPGs), video-on-demand catalogs, and content management systems (CMS). This metadata may be preprocessed, with steps including stop word removal, conversion to lowercase, and lemmatization. The system may also transform the metadata from formats such as XML into more usable formats like CSV, facilitating the conversion of textual descriptions into vector embeddings. To further improve performance, the embeddings may be quantized to 8-bit or 16-bit precision, reducing memory usage while preserving semantic information.

During query processing, the system receives search queries from client applications and processes them using the same sentence transformer model used for video metadata. The system may convert these queries into vector embeddings, which may then be compared against the indexed embeddings of the video metadata using cosine similarity or other machine learning algorithms. The search results may be ranked based on their similarity scores so that the most relevant videos are returned to the user. Deduplication logic may be used so that multiple embeddings corresponding to the same video asset do not produce duplicate results, and the system efficiently links the vector embeddings back to the original video metadata, such as video identifiers and image URLs.

In handling multilingual content, such as video metadata in English and Spanish, the system may support multiple languages by using pre-trained sentence transformers fine-tuned for specific language tasks. This feature allows the system to return semantically relevant results for multilingual queries.

The system overcomes several technical challenges, including efficiently linking vector embeddings back to video metadata and optimizing the indexing process at the edge. The use of FAISS for dimensionality reduction and custom code to map embeddings to metadata ensures that the system is both scalable and efficient, solving problems not addressed by traditional text-based search methods. These solutions allow for real-time, context-based video content discovery, improving both search accuracy and system performance across multiple edge nodes.

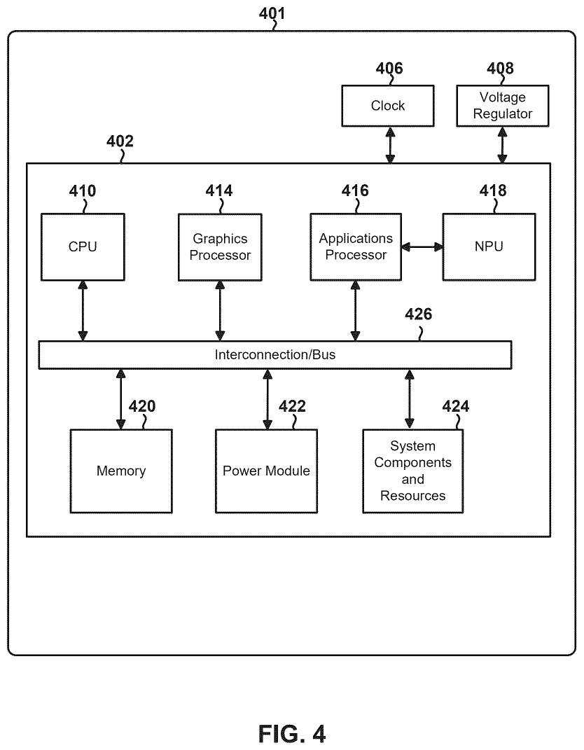

FIG. 4 is a component block diagram of an example computing system 401 suitable for implementing some embodiments. The computing system 401 may include a system on chip (SoC) 402 designed to execute semantic video metadata search at edge locations in a network communication system. The SoC 402 may include various processing units such as a central processing unit (CPU) 410, a graphics processing unit (GPU) 414, and an applications processor 416, all interconnected to perform the computational tasks described in the embodiments. In some configurations, the SoC 402 may also include a neural processing unit (NPU) 418 or a dedicated machine learning accelerator to enhance the processing of transformer models and vector embeddings. The SoC 402 may also include memory 420, a power module 422, and various system components and resources 424.

The SoC 402 may be configured to execute software instructions related to semantic video metadata search, including preprocessing of video metadata, converting metadata into high-dimensional vector embeddings using transformer models, indexing vector embeddings, and performing similarity-based searches. Each processor 410, 414, 416, and 418 may execute instructions concurrently for parallel processing of tasks such as data preprocessing, vectorization, indexing, and query handling. These processors may communicate and share data through an interconnection/bus module 426, which may implement a high-performance bus architecture that allows for seamless data transfer between processing units and memory components.

In some embodiments, the processors within the SoC 402 may operate in a multicore configuration to handle complex computations efficiently. Each processor or core may manage specific aspects of the semantic search process, such as running transformer models, managing the indexing system, and handling client queries, thereby reducing computational load and improving performance. The SoC 402 may be integrated into a heterogeneous processor cluster architecture to support coordinated operation across processors, which may allow the system to manage multiple client applications simultaneously at the edge location.

The SoC 402 may further include an input/output module (not illustrated) for communicating with external resources, such as network interfaces for receiving video metadata and client search queries and for transmitting search results. These external resources may support connectivity with metadata sources, client applications, and other network devices required for the semantic search processes. The input/output module may handle protocols and communication standards necessary for efficient data exchange.

The SoC 402 may include various system components, resources, and custom circuitry for managing data storage, vector computations, and other specialized operations. For example, the system components and resources 424 may include memory controllers, data storage units (e.g., solid-state drives or flash memory), network interface controllers, and other components used to support the processors and software clients running on the computing device at the edge location. The system components and resources 424 may also include circuitry to interface with peripheral devices, such as displays, input devices, and external memory chips.

In addition to the example computing system 401, the described embodiments may be implemented on a wide range of computing systems, including configurations with single processors, multicore processors, or clusters of processors. The flexibility of the described architecture allows the system to scale adequately to meet the computational needs of various edge deployments, supporting efficient semantic video metadata search functionality in different network environments.

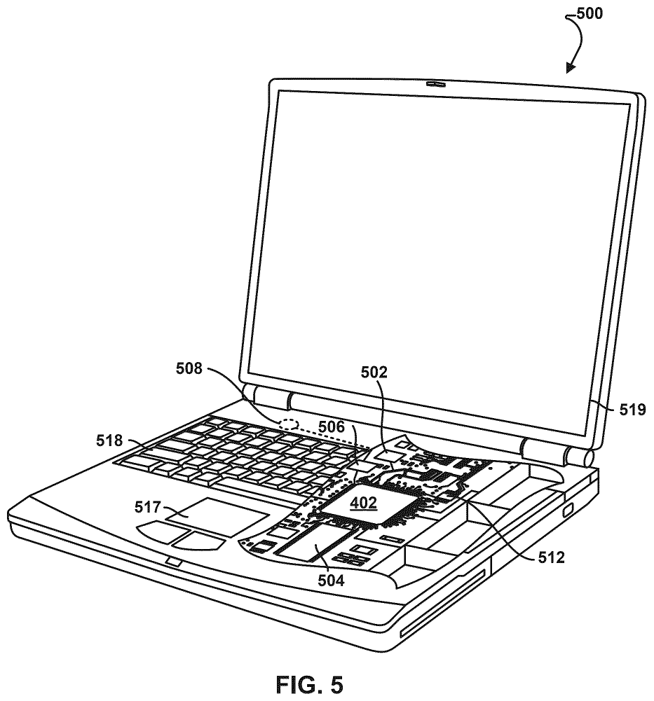

FIG. 5 is a component block diagram of an edge device 500 suitable for use with various embodiments. With reference to FIGS. 1-5, various embodiments may be implemented on a variety of edge devices, an example of which is illustrated in FIG. 5 in the form of a laptop computer 500. A laptop 500 may include a SoC 402 and/or a processor 502 coupled to a memory 504, which may include standard-performance memory, high-performance memory, volatile memory, non-volatile memory, dynamic memory, static memory, or any combination thereof. For example, memory 504 may include dynamic random-access memory (DRAM) for volatile storage and non-volatile memory such as flash or solid-state storage, such as a Non-Volatile Memory Express (NVMe) solid-state drive (SSD) 506. The laptop 500 may include multiple antennas designed to support various wireless communication standards, including Wi-Fi 6/6E, 5G cellular connectivity, and Bluetooth. These antennas are connected to a wireless data link and a cellular transceiver 512, both of which are coupled to the processor 502. In addition, the laptop 500 may include a precision touchpad 517 that supports multi-touch gestures and other modern input/output peripherals, such as a backlit keyboard 518 and a high-resolution display 519 (e.g., 4K OLED or Mini-LED). The laptop 500 may also include biometric sensors for authentication, such as a fingerprint reader 508 or facial recognition, all of which are integrated and controlled by the processor 502.

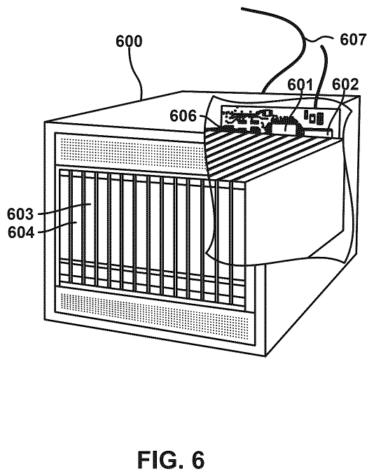

All or portions of some embodiments may be implemented in the cloud or on a variety of commercially available computing devices, such as the server computing device 600 illustrated in FIG. 6. The server device 600 may include one or more processors 601 (e.g., multi-core processor, etc.) coupled to volatile memory 602, such as RAM, and a large capacity nonvolatile memory, such as a solid-state drive (SSD) 603. The server device 600 may also include additional storage interfaces such as USB ports and NVMe slots coupled to the processor 601. The server device 600 may include network access ports 606 coupled to the processor 601 that allow data connections through a network interface card (NIC) 604 and a communication network 607 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Computing devices often include multiple processors, with dedicated processors for specific tasks. Software applications may be stored in the internal memory before being accessed and executed by the processor. Modern processors may include extensive internal memory, often augmented with fast access cache memory, to efficiently store and process application software instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). In addition, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-enhanced hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

1. A method for generating an index for performing semantic search on video metadata at an edge location, comprising:
receiving, at a processing system of a computing device, video metadata associated with one or more video assets from at least one metadata source;
preprocessing the video metadata by removing stop words, punctuation, and irrelevant terms, converting the video metadata to lowercase, and performing lemmatization to standardize word forms;
converting the preprocessed video metadata into high-dimensional vector embeddings using a pre-trained transformer;
indexing, by the processing system, the high-dimensional vector embeddings along with corresponding video identifiers and image uniform resource locators (URLs ) in the index, wherein each high-dimensional vector embedding corresponds to one or more metadata fields of the video metadata; and
deploying the index to an edge location of a content delivery network (CDN) or edge computing platform.

2. The method of claim 1, further comprising:
receiving, at the edge location, a semantic search query from a client application;
preprocessing the semantic search query by removing stop words, punctuation, and irrelevant terms, converting the semantic search query to lowercase, and performing lemmatization to standardize word forms;
converting the preprocessed semantic search query into a query vector embedding using the pre-trained transformer;
searching the index using the query vector embedding to retrieve one or more matching vector embeddings corresponding to the video metadata;
retrieving, based on the retrieved matching vector embeddings, corresponding video identifiers and image URLs associated with the one or more video assets; and
sending to the client application the video identifiers and image URLs corresponding to the one or more video assets as search results.

3. The method of claim 1, wherein preprocessing the video metadata further comprises parsing the video metadata into one or more metadata fields that each include at least one of a title, description, actor, or genre.

4. The method of claim 3, wherein converting the preprocessed video metadata into high-dimensional vector embeddings further comprises generating a separate high-dimensional vector embedding for each metadata field associated with the video metadata.

5. The method of claim 4, further comprising storing the high-dimensional vector embeddings and corresponding video metadata in a structured format that maintains index alignment between the video metadata and the high-dimensional vector embeddings.

6. The method of claim 2, wherein the pre-trained transformer is a BERT-based model configured to convert the video metadata and the semantic search query into high-dimensional vector embeddings.

7. The method of claim 2, further comprising performing dimensionality reduction on the high-dimensional vector embeddings before indexing the high-dimensional vector embeddings at the edge location, wherein the dimensionality reduction comprises at least one or more of:
principal component analysis (PCA); or
scalar quantization.

8. The method of claim 7, wherein performing scalar quantization comprises applying 8-bit or 16-bit quantization to reduce the memory and storage requirements for the high-dimensional vector embeddings at the edge location.

9. The method of claim 2, wherein indexing the high-dimensional vector embeddings further comprises indexing the high-dimensional vector embeddings using a similarity-based search index, wherein the similarity-based search index is created using artificial intelligence similarity search (AISS).

10. The method of claim 2, wherein receiving the semantic search query from the client application further comprises transmitting the semantic search query to the edge location from a client device, the client device being associated with a video streaming or content discovery application.

11. The method of claim 2, wherein retrieving corresponding video identifiers and image URLs further comprises deduplicating the search results to remove duplicate entries resulting from multiple vector embeddings corresponding to the same video asset.

12. The method of claim 2, wherein the edge location comprises a set-top box or an edge computing device deployed within the content delivery network.

13. The method of claim 2, further comprising updating the index at the edge location with newly generated vector embeddings corresponding to newly added video assets.

14. The method of claim 2, wherein retrieving corresponding video identifiers and image URLs further comprises sorting the search results based on a similarity score between the query vector embedding and the retrieved matching vector embeddings.

15. The method of claim 2, further comprising deploying a Python API wrapper to the edge location, wherein the Python API wrapper encapsulates the functionality of indexing the high-dimensional vector embeddings, performing the semantic search, and returning the search results to the client application.

16. The method of claim 2, further comprising monitoring the latency and performance of the edge location and adjusting dimensionality reduction parameters to enhance search performance and memory usage at the edge location.

17. The method of claim 2, wherein the pre-trained transformer is RoBERTa or another transformer model configured to generate high-dimensional vector embeddings from video metadata and search queries.

18. The method of claim 2, wherein the video metadata is obtained from one or more electronic program guides (EPGs) or on-demand video catalogs.

19. The method of claim 2, further comprising displaying, at the client application, the search results including the video identifiers and image URLs, wherein the image URLs are displayed as video thumbnails or posters in a user interface.

20. The method of claim 2, wherein the edge location is configured to handle multiple client applications simultaneously by balancing search requests across multiple edge nodes.

21. The method of claim 2, further comprising storing the high-dimensional vector embeddings and video metadata in at least one NumPy array to enhance memory usage and indexing performance at the edge location.

22. A computing system, comprising:
at least one hardware processor in a processing system configured to:
receive video metadata associated with one or more video assets from at least one metadata source;
preprocess the video metadata by removing stop words, punctuation, and irrelevant terms, converting the video metadata to lowercase, and performing lemmatization to standardize word forms;
convert the preprocessed video metadata into high-dimensional vector embeddings using a pre-trained transformer;
index the high-dimensional vector embeddings along with corresponding video identifiers and image URLs in an index, wherein each high-dimensional vector embedding corresponds to one or more metadata fields of the video metadata; and
deploy the index to an edge location of a content delivery network (CDN) or edge computing platform.

23. The computing system of claim 22, wherein the at least one hardware processor is configured to:
receive, at the edge location, a semantic search query from a client application;
preprocess the semantic search query by removing stop words, punctuation, and irrelevant terms, converting the semantic search query to lowercase, and performing lemmatization to standardize word forms;
convert the preprocessed semantic search query into a query vector embedding using the pre-trained transformer;
search the index using the query vector embedding to retrieve one or more matching vector embeddings corresponding to the video metadata;
retrieve, based on the retrieved matching vector embeddings, corresponding video identifiers, and image URLs associated with the one or more video assets; and
send to the client application the video identifiers and image URLs corresponding to the one or more video assets as search results.

24. The computing system of claim 22, wherein the at least one hardware processor is configured to preprocess the video metadata by parsing the video metadata into one or more metadata fields that each include at least one of a title, description, actor, or genre.

25. The computing system of claim 24, wherein the at least one hardware processor is configured to convert the preprocessed video metadata into high-dimensional vector embeddings by generating a separate high-dimensional vector embedding for each metadata field associated with the video metadata.

26. The computing system of claim 25, wherein the at least one hardware processor is configured to store the high-dimensional vector embeddings and corresponding video metadata in a structured format that maintains index alignment between the video metadata and the high-dimensional vector embeddings.

27. The computing system of claim 23, wherein the pre-trained transformer is a BERT-based model configured to convert the video metadata and the semantic search query into high-dimensional vector embeddings.

28. The computing system of claim 23, wherein:
the at least one hardware processor is configured to perform dimensionality reduction on the high-dimensional vector embeddings before indexing the high-dimensional vector embeddings at the edge location; and
the dimensionality reduction comprises at least one or more of:
principal component analysis (PCA); or
scalar quantization.

29. The computing system of claim 28, wherein the at least one hardware processor is configured to perform scalar quantization by applying 8-bit or 16-bit quantization to reduce the memory and storage requirements for the high-dimensional vector embeddings at the edge location.

30. The computing system of claim 23, wherein the at least one hardware processor is configured to index the high-dimensional vector embeddings by indexing the high-dimensional vector embeddings using a similarity-based search index, wherein the similarity-based search index is created using artificial intelligence similarity search (AISS).

31. The computing system of claim 23, wherein the at least one hardware processor is configured to receive the semantic search query from the client application by transmitting the semantic search query to the edge location from a client device, the client device being associated with a video streaming or content discovery application.

32. The computing system of claim 23, wherein the at least one hardware processor is configured to retrieve corresponding video identifiers and image URLs by deduplicating the search results to remove duplicate entries resulting from multiple vector embeddings corresponding to the same video asset.

33. The computing system of claim 23, wherein the at least one hardware processor is included in a set-top box or an edge computing device deployed within the content delivery network.

34. The computing system of claim 23, wherein the at least one hardware processor is configured to update the index at the edge location with newly generated vector embeddings corresponding to newly added video assets.

35. The computing system of claim 23, wherein the at least one hardware processor is configured to retrieve corresponding video identifiers and image URLs by sorting the search results based on a similarity score between the query vector embedding and the retrieved matching vector embeddings.

36. The computing system of claim 23, wherein the at least one hardware processor is configured to deploy a Python API wrapper to the edge location, wherein the Python API wrapper encapsulates the functionality of indexing the high-dimensional vector embeddings, performing the semantic search, and returning the search results to the client application.

37. The computing system of claim 23, wherein the at least one hardware processor is configured to monitor the latency and performance of the edge location and adjust dimensionality reduction parameters to enhance search performance and memory usage at the edge location.

38. The computing system of claim 23, wherein the pre-trained transformer is ROBERTa or another transformer model configured to generate high-dimensional vector embeddings from video metadata and search queries.

39. The computing system of claim 23, wherein the at least one hardware processor is configured to obtain the video metadata from one or more electronic program guides (EPGs) or on-demand video catalogs.

40. The computing system of claim 23, wherein:
the at least one hardware processor is configured to display, at the client application, the search results that include the video identifiers and image URLs; and
the image URLs are displayed as video thumbnails or posters in a user interface.

41. The computing system of claim 23, wherein the at least one hardware processor is at the edge location and configured to handle multiple client applications simultaneously by balancing search requests across multiple edge nodes.

42. The computing system of claim 23, wherein the at least one hardware processor is configured to store the high-dimensional vector embeddings and video metadata in at least one NumPy array to enhance memory usage and indexing performance at the edge location.

43. A non-transitory processor-readable storage medium having stored thereon processor-executable instructions to cause at least one processor in a processing system of a computing system to perform various operations for generating an index for performing semantic search on video metadata at an edge location, the operations comprising:
receiving video metadata associated with one or more video assets from at least one metadata source;
preprocessing the video metadata by removing stop words, punctuation, and irrelevant terms, converting the video metadata to lowercase, and performing lemmatization to standardize word forms;
converting the preprocessed video metadata into high-dimensional vector embeddings using a pre-trained transformer;
indexing the high-dimensional vector embeddings along with corresponding video identifiers and image URLs in the index, wherein each high-dimensional vector embedding corresponds to one or more metadata fields of the video metadata; and
deploying the index to an edge location of a content delivery network (CDN) or edge computing platform.

44. The non-transitory processor-readable storage medium of claim 43, wherein the stored processor-executable instructions are configured to cause at least one processor to perform operations further comprising:
receiving, at the edge location, a semantic search query from a client application;
preprocessing the semantic search query by removing stop words, punctuation, and irrelevant terms, converting the semantic search query to lowercase, and performing lemmatization to standardize word forms;
converting the preprocessed semantic search query into a query vector embedding using the pre-trained transformer;
searching the index using the query vector embedding to retrieve one or more matching vector embeddings corresponding to the video metadata;
retrieving, based on the retrieved matching vector embeddings, corresponding video identifiers, and image URLs associated with the one or more video assets; and
sending to the client application the video identifiers and image URLs corresponding to the one or more video assets as search results.

45. The non-transitory processor-readable storage medium of claim 43, wherein the stored processor-executable instructions are configured to cause the at least one processor to perform operations such that preprocessing the video metadata further comprises parsing the video metadata into one or more metadata fields that each include at least one of a title, description, actor, or genre.

46. The non-transitory processor-readable storage medium of claim 45, wherein the stored processor-executable instructions are configured to cause the at least one processor to perform operations such that converting the preprocessed video metadata into high-dimensional vector embeddings further comprises generating a separate high-dimensional vector embedding for each metadata field associated with the video metadata.

47. The non-transitory processor-readable storage medium of claim 46, wherein the stored processor-executable instructions are configured to cause the at least one processor to perform operations further comprising storing the high-dimensional vector embeddings and corresponding video metadata in a structured format that maintains index alignment between the video metadata and the high-dimensional vector embeddings.

48. The non-transitory processor-readable storage medium of claim 44, wherein the stored processor-executable instructions are configured to cause the at least one processor to perform operations such that the pre-trained transformer is a BERT-based model configured to convert the video metadata and the semantic search query into high-dimensional vector embeddings.

49. The non-transitory processor-readable storage medium of claim 44, wherein the stored processor-executable instructions are configured to cause the at least one processor to perform operations further comprising performing dimensionality reduction on the high-dimensional vector embeddings before indexing the high-dimensional vector embeddings at the edge location, wherein the dimensionality reduction comprises at least one or more of:
principal component analysis (PCA); or
scalar quantization.

50. The non-transitory processor-readable storage medium of claim 49, wherein the stored processor-executable instructions are configured to cause the at least one processor to perform operations such that performing scalar quantization comprises applying 8-bit or 16-bit quantization to reduce the memory and storage requirements for the high-dimensional vector embeddings at the edge location.

51. The non-transitory processor-readable storage medium of claim 44, wherein the stored processor-executable instructions are configured to cause the at least one processor to perform operations such that indexing the high-dimensional vector embeddings further comprises indexing the high-dimensional vector embeddings using a similarity-based search index, wherein the similarity-based search index is created using artificial intelligence similarity search (AISS).

52. The non-transitory processor-readable storage medium of claim 44, wherein the stored processor-executable instructions are configured to cause the at least one processor to perform operations such that receiving the semantic search query from the client application further comprises transmitting the semantic search query to the edge location from a client device, the client device being associated with a video streaming or content discovery application.

53. The non-transitory processor-readable storage medium of claim 44, wherein the stored processor-executable instructions are configured to cause the at least one processor to perform operations such that retrieving corresponding video identifiers and image URLs further comprises deduplicating the search results to remove duplicate entries resulting from multiple vector embeddings corresponding to the same video asset.

54. The non-transitory processor-readable storage medium of claim 44, wherein the at least one processor is included in set-top box or an edge computing device deployed within a content delivery network.

55. The non-transitory processor-readable storage medium of claim 44, wherein the stored processor-executable instructions are configured to cause the at least one processor to perform operations further comprising updating the index at the edge location with newly generated vector embeddings corresponding to newly added video assets.

56. The non-transitory processor-readable storage medium of claim 44, wherein the stored processor-executable instructions are configured to cause the at least one processor to perform operations such that retrieving corresponding video identifiers and image URLs further comprises sorting the search results based on a similarity score between the query vector embedding and the retrieved matching vector embeddings.

57. The non-transitory processor-readable storage medium of claim 44, wherein the stored processor-executable instructions are configured to cause the at least one processor to perform operations further comprising deploying a Python API wrapper to the edge location, wherein the Python API wrapper encapsulates the functionality of indexing the high-dimensional vector embeddings, performing the semantic search, and returning the search results to the client application.

58. The non-transitory processor-readable storage medium of claim 44, wherein the stored processor-executable instructions are configured to cause the at least one processor to perform operations further comprising monitoring the latency and performance of the edge location and adjusting dimensionality reduction parameters to enhance search performance and memory usage at the edge location.

59. The non-transitory processor-readable storage medium of claim 44, wherein the stored processor-executable instructions are configured to cause the at least one processor to perform operations such that the pre-trained transformer is ROBERTa or another transformer model configured to generate high-dimensional vector embeddings from video metadata and search queries.

60. The non-transitory processor-readable storage medium of claim 44, wherein the stored processor-executable instructions are configured to cause the at least one processor to perform operations such that the video metadata is obtained from one or more electronic program guides (EPGs) or on-demand video catalogs.

61. The non-transitory processor-readable storage medium of claim 44, wherein the stored processor-executable instructions are configured to cause the at least one processor to perform operations further comprising displaying, at the client application, the search results including the video identifiers and image URLs, wherein the image URLs are displayed as video thumbnails or posters in a user interface.

62. The non-transitory processor-readable storage medium of claim 44, wherein the stored processor-executable instructions are configured to cause the at least one processor to perform operations such that the edge location is configured to handle multiple client applications simultaneously by balancing search requests across multiple edge nodes.

63. The non-transitory processor-readable storage medium of claim 44, wherein the stored processor-executable instructions are configured to cause the at least one processor to perform operations further comprising storing the high-dimensional vector embeddings and video metadata in at least one NumPy array to enhance memory usage and indexing performance at the edge location.
